(19) United States
(12) Patent Application Publication
(10) Pub. No.: US 2014/0279200 A1
(43) Pub. Date: Sep. 18, 2014

(54) DESTINATION SHOPPING SYSTEM

(71) Applicants: Marc Peter Hosein, Saratoga, CA (US); Steve Yankovich, San Jose, CA (US); Krystal Rose Higgins, Campbell, CA (US)

(72) Inventors: Marc Peter Hosein, Saratoga, CA (US); Steve Yankovich, San Jose, CA (US); Krystal Rose Higgins, Campbell, CA (US)

(73) Assignee: EBAY INC., SAN JOSE, CA (US)

(21) Appl. No.: 14/109,062

(22) Filed: Dec. 17, 2013

Related U.S. Application Data
(60) Provisional application No. 61/800,568, filed on Mar. 15, 2013.

(51) Int. Cl. G06Q 30/06

(52) U.S. Cl. CPC G06Q 30/0601
USPC 705/26.7; 705/26.1; 705/14.63

(57) ABSTRACT

Techniques for facilitating a shopping experience based on a passenger's destination are described. According to various embodiments, a destination location of a passenger on a vehicle is determined. Contextual electronic content is then selected, based on the destination location of the passenger. Thereafter, the contextual electronic content is displayed via a user interface on a vehicle passenger seat display screen associated with the passenger or on the passenger's mobile device.

### CROSS-REFERENCE TO RELATED APPLICATIONS

This application claims the priority benefit of U.S. Provisional Application No. 61/800,568, filed Mar. 15, 2013, which is incorporated herein by reference.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

The present application relates generally to data processing systems and, in one specific example, to techniques for facilitating a shopping experience based on a passenger's destination.

### BACKGROUND

Passengers traveling on board a vehicle (e.g., aircraft, train, bus, car, sea vessel, etc.) often bring along their smart phones, tablets, or other mobile devices, in order to keep themselves occupied during their journey. In many modern commercial airliners, each passenger seat on the aircraft also has its own display screen for passengers to view television and movies.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed;

FIG. 2 is a block diagram of an example system, according to various embodiments;

FIG. 3 is a flowchart illustrating an example method, according to various embodiments;

FIG. 4 illustrates an example of exemplary passenger information corresponding to a passenger manifest for a particular flight, according to various embodiments;

FIGS. 5A and 5B illustrate examples of itinerary information for various passengers, according to various embodiments;

FIG. 6 illustrates an exemplary user interface that displays various contextual or personalized content related to a destination of a passenger, according to various embodiments;

FIG. 7 illustrates an exemplary user interface, according to various embodiments;

FIG. 8 is a flowchart illustrating an example method, according to various embodiments;

FIG. 9 illustrates an exemplary user interface, according to various embodiments;

FIG. 10 is a flowchart illustrating an example method, according to various embodiments;

FIG. 11 illustrates an exemplary user interface, according to various embodiments;

FIG. 12 illustrates an exemplary user interface, according to various embodiments;

FIG. 13 is a flowchart illustrating an example method, according to various embodiments;

FIG. 14 is a flowchart illustrating an example method, according to various embodiments;

FIG. 15 is a flowchart illustrating an example method, according to various embodiments;

FIG. 16 is a flowchart illustrating an example method, according to various embodiments;

FIG. 17 is a flowchart illustrating an example method, according to various embodiments;

FIG. 18 illustrates an exemplary mobile device, according to various embodiments; and

FIG. 19 is a diagrammatic representation of a machine in the example form of a computer system within which a set of instructions, for causing the machine to perform any one or more of the methodologies discussed herein, may be executed.

### DETAILED DESCRIPTION

Example methods and systems for facilitating a shopping experience based on a passenger's destination are described. In the following description, for purposes of explanation, numerous specific details are set forth in order to provide a thorough understanding of example embodiments. It will be evident, however, to one skilled in the art that the present invention may be practiced without these specific details.

According to various exemplary embodiments, a destination shopping system is configured to facilitate the shopping experience of a passenger (e.g., a passenger traveling on an aircraft, train, bus, sea vessel, etc.). In particular, the destination shopping system is configured to provide the shopping experience for a passenger that is customized or personalized for the passenger based on their destination.

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may be implemented on or executed by one or more of the modules of the destination shopping system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102. With some embodiments, the application servers 118 hosts what is referred to herein as a destination shopping system 200. The destination shopping system 200 is described in more detail below in conjunction with FIG. 2.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

Turning now to FIG. 2, a destination shopping system 200 includes a determination module 202, a content management module 204, and a database 206. The modules of the destination shopping system 200 may be implemented on a single device such as a destination shopping device, or on separate devices interconnected via a network. The aforementioned destination shopping device may correspond to, for example, one of the client machines (e.g. 110, 112) or application server(s) 118 illustrated in FIG. 1.

According to various exemplary embodiments, the destination shopping system 200 is configured to facilitate the shopping experience for a passenger (e.g., a passenger traveling on an aircraft, train, bus, sea vessel, etc.), by providing a shopping experience for the passenger that is customized based on the passenger's final destination.

For example, FIG. 3 is a flowchart illustrating an example method 300, according to various embodiments. The method 300 may be performed at least in part by, for example, the destination shopping system 200 illustrated in FIG. 2 (or an apparatus having similar modules, such as client machines 110 and 112 or application server 112 illustrated in FIG. 1). In operation 301, the determination module 202 determines a destination location of a user (e.g., a passenger). In operation 302, the content management module 204 selects contextual electronic content, based on the destination location of the user that was determined in operation 301. In 303, the content management module 204 generates a display (via a user interface) of the contextual electronic content that was selected in operation 302. The operation of each of the modules of the destination shopping system 200 will now be described in more detail.

According to various exemplary embodiments, the determination module 202 of the destination shopping system 200 may determine the final destination of a particular passenger (e.g., traveling on a commercial airline flight) based on, for example, passenger information associated with that passenger. For example, various commercial airlines, travel agencies, and travel-related websites may maintain passenger information for each passenger on a flight, where such passenger information may correspond to, for example, passenger records, a passenger manifest, loading manifest, seat assignment information, etc. Such passenger information may be stored in the database 206. Such passenger information may include the name of the user, the seat assignment of the user, and a final destination of the user. Note that if the user is on a particular flight, their final destination may not correspond to the destination of that particular flight. Thus, the passenger information for that user may reference a user itinerary of the user indicating, for example, the final destination of the user and a hotel where the user is staying.

FIG. 4 illustrates an example of exemplary passenger information 400 corresponding to a passenger manifest for a particular flight. As illustrated in FIG. 4, the passenger information 400 identifies, for each of a plurality of users on the flight, the name of the user, the seat assigned to the user, the date of birth of the user, the age of the user, the sex of the user, a final destination of the user, a link to itinerary information for the user, and credit card or electronic payment information associated with the user (e.g., a credit card or electronic payment account number that the user used to purchase the ticket for the flight). FIG. 5A illustrates exemplary itinerary information 500 for the user John Smith illustrated in FIG. 4. As illustrated in FIG. 5A, the exemplary itinerary information 500 identifies the travel plans of the user, such as various flights that the user is taking, the final destination of the user (e.g., airport and/or city), a hotel or address where the user is staying at their final destination, and so on. As another example, FIG. 5B illustrates exemplary itinerary information 501 for the user Jane Doe illustrated in FIG. 4. The exemplary passenger information (e.g., 400) or exemplary itinerary information (e.g., 500 and 501) described above may be stored locally at, for example, the database 206 illustrated in FIG. 2, or may be stored remotely at a database, data repository, storage server, etc., that is accessible by the 200 via a network (e.g., the Internet).

After the determination module 202 determines the final destination of the user, the content management module 204 may customize or personalize content provided to the user based on their final destination. The content management module 204 may display content to the user via a user interface on a display screen installed in an aircraft. For example, many commercial aircraft today include a touch-sensitive display screen installed in conjunction with each passenger seat, such that every passenger in the aircraft has their own touch-sensitive display screen. Thus, the content management module 204 may display content onto the touchscreen associated with a given passenger seat, based on the final destination of the passenger sitting in that passenger seat. As another example, the content management module 204 may transmit or push content onto a device of the user, such as a mobile device (e.g., a cell phone, smart form, laptop computer, notebook computer, tablet computing device, etc.). For example, the content management module 204 may establish a connection with the device of the user via a Bluetooth connection, Near Field Communication (NFC) connection, a Bump connection, a connection over any one of various communication networks including the Internet, a local area network, and intranet, etc.

The destination shopping system 200 may display advertisements, coupons, promotions, offers, suggestions, recommendations, items for purchase, etc., that are customized for the user's destination and are likely to be of interest to the user (e.g., see the user interface 600 in FIG. 6). For example, the destination shopping system 200 may display items that are historically popular for other users located in (or traveling to) the final destination (e.g., Miami Fla. or Anchorage Ak.). The destination shopping system 200 may display items for sale customized based on the current or predicted climate or weather at the final destination. As one example, the destination shopping system 200 may display items for sale such as warm weather clothes, sunglasses, sunscreen, swimming attire, etc., for the final destination Miami, Fla. for the user John Smith. On the other hand, the destination shopping system 200 may display items for sale such as cold-weather clothes, hats, gloves, scarves, lip balm, etc., for the final destination Anchorage, Ak. of the user Jane Doe. As another example, the destination shopping system 200 may display items for sale related to popular activities, events, services, shows, performances, tourist attractions, etc., located at the final destination of each user (e.g., see the user interface 600 in FIG. 6). For example, the destination shopping system 200 can allow the user to make dinner reservations in the final destination city (perhaps at a location near the hotel). For example, the destination shopping system 200 may display ads for an upcoming concert in the final destination city. The destination shopping system 200 can also display ads for apparel, memorabilia, or accessories associated with upcoming events. Receipts for any products purchased may be transmitted to an e-mail address associated with the user or pushed onto a mobile device of the user. The content displayed to the user is not limited, and may include various types of content including coupons, brochures, promotions, advertisements, interactive shopping features, websites, webpages, blogs, posts on forums or bulletin boards, articles, news, presentations, reviews, and so on.

According to various exemplary embodiments, the content surfaced by the destination shopping system 200 may take into account not only the final destination city of the user, but also the origin of the user. For example, if the user is flying from San Francisco Bay Area to New York, the destination shopping system 200 can display content regarding upcoming events where sporting teams from the San Francisco Bay Area are playing away games against New York sporting teams in New York. In some embodiments, the destination shopping system 200 may display content related to where the user's vessel happens to be traveling near. For example, if the passenger's flight is currently flying over Mount Rushmore, the destination shopping system 200 may surface content related to Mount Rushmore (e.g., pictures, postcards, documentaries, etc.).

The contents displayed by the destination shopping system 200 may be further contextualized for the user based on not just the destination city, but also the specific suburb, street, and hotel or address where the user is staying. For example, the destination shopping system 200 may display ads, promotions, items for sale, etc., for retailers that are located at or near the hotel where the user is staying in the final destination city (e.g., see FIG. 6).

Thus, according to various exemplary embodiments, since seat number and passenger records are on file, an in-flight entertainment system (e.g., a destination shopping system 200) can access the passenger records (e.g., final destination city, hotel, name, age, sex, etc.) for each passenger. Based on this information, the system can surface contextualized offers, advertisements, and recommendations on each passenger's touchscreen based on, for example, each passenger's final destination. Thus, whereas all passengers on a flight are currently provided with the same generic in-flight entertainment experience, according to various exemplary embodiments, different passengers on the same flight are provided with a different in-flight entertainment and shopping experience, based on the final destination of each passenger.

According to various exemplary embodiments, since the destination shopping system 200 has access to the passenger records and/or itinerary for each passenger on the vessel (including information about the hotel where the passenger is staying), any items purchased by the user via the destination shopping system 200 may be automatically delivered to the airport, car rental facility, hotel address or other location where the user will be visiting or staying in the final destination city. Alternatively, the location where the user will be visiting or staying may be automatically prefilled into various user interface fields in a shopping order user interface screen (e.g., see the user interface 700 in FIG. 7).

According to various exemplary embodiments, if the destination shopping system 200 has access to financial information for each passenger (e.g., credit card information, electronic payment information, PayPal account information, etc.), any items purchased by the user may be automatically charged to an appropriate account based on this financial information. For example, products purchased by the user may be charged to the user's PayPal account. This financial information of the user may be automatically pre-filled into various user interface fields in a shopping order interface (e.g., see the user interface 700 in FIG. 7).

FIG. 8 is a flowchart illustrating an example method 800, consistent with various embodiments described above. The method 800 may be performed at least in part by, for example, the destination shopping system 200 illustrated in FIG. 2 (or an apparatus having similar modules, such as client machines 110 and 112 or application server 118 illustrated in FIG. 1). In operation 801 in FIG. 8, the content management module 204 receives, via a user interface, a product purchase selection of a product item. For example, a user (e.g., a passenger) may click on a “purchase”, “check out”, or “buy it now” user interface element on an e-commerce or retailer website (which may be displayed on the seat screen associated with the passenger or the passenger's smartphone). In operation 802 in FIG. 8, the content management module 204 automatically specifies, based on the destination location (e.g., as determined in operation 301 in FIG. 3), a delivery address in conjunction with the product purchase selection by the passenger. In some embodiments, the delivery address may correspond to a destination airport or destination hotel associated with the passenger, as determined based on a passenger manifest, seat records, passenger inventory, passenger itinerary information, etc. In operation 803 in FIG. 8, the content management module 204 automatically specifies, based on electronic payment information associated with the passenger, payment information in conjunction with the product purchase selection by the passenger.

According to various exemplary embodiments, the destination shopping system 200 can adjust the experience for a passenger if the passenger has changed seats. For example, if the destination shopping system 200 determines that the passenger John Smith has moved from seat 12A to seat 12B, and the passenger Jane Doe has moved from seat 12B to seat 12A, then the destination shopping system 200 may adjust the shopping experience for the touchscreens in seats 12A and 12B accordingly. The destination shopping system 200 can determine that the users have changed seats based on, for example, facial recognition of the users, explicit data input indicating the change that is input by crew members or the passengers themselves into the destination shopping system 200, etc.

According to various exemplary embodiments, contextualized offers surfaced for a first passenger may also be surfaced by a destination shopping system 200 for other passengers with some connection to the first passenger (e.g., a group of passengers on the same itinerary who purchased tickets together, or a group of passengers engaged in an online group chat session). This may be leveraged in terms of group buy transactions or group deals for the connected users (e.g., offering cruise tickets for half price if 4 users purchase the cruise tickets) (e.g., see the user interface 900 in FIG. 9). In addition to determining that multiple users have some connection, the destination shopping system 200 may also optionally determine that the connected users have a common final destination, before surfacing content between the users and/or leveraging the connection between the users for group buy transactions.

The destination shopping system 200 may determine that multiple passengers have some connection based on various factors. For example, the destination shopping system 200 may determine that the user John Galloway in seat 15A and the user Simon Galloway in seat 23C have some inferred connection (e.g., it can be inferred that they are related because they have the same unique, uncommon last name). As another example, the destination shopping system 200 may determine that the user Jim Sample and Jane Sample have a connection, because their tickets are purchased together and/or they are listed on the same itinerary or have a common itinerary. As another example, the destination shopping system 200 may determine that the users in seats 1D, 19C, and 31A have a connection to each other, since they have been engaged in an online chat session via an instant message program of an aircraft in-flight entertainment system (e.g., they have sent more than a predetermined number of messages to each other and/or they have been messaging each other for more than a predetermined time). As another example, since the destination shopping system 200 has access to passenger records including passenger names, the destination shopping system 200 may access a social media account associated with the one or more of the passengers, in order to determine who each passenger is connected to, associated with, following, etc. on an online social networking service. According to various exemplary embodiments, the connection could be that multiple users are staying at the same hotel or location, per the user itineraries. According to various exemplary embodiments, a passenger can explicitly invite other passengers to participate in a group buy deal for a product or an event. Thus, a connection between users can be determined based on an explicit specification of such connection by a passenger.

FIG. 10 is a flowchart illustrating an example method 1000, consistent with various embodiments described above. The method 1000 may be performed at least in part by, for example, the destination shopping system 200 illustrated in FIG. 2 (or an apparatus having similar modules, such as client machines 110 and 112 or application server 118 illustrated in FIG. 1). In operation 1001 in FIG. 10, the content management module 204 determines that a user (e.g., a passenger) is associated with one or more additional passengers in a vehicle. In operation 1002 in FIG. 10, the content management module 204 displays contextual electronic content to the passenger and the one or more additional passengers. In some embodiments, the contextual electronic content corresponds to an offer or recommendation for a group buy deal.

According to various exemplary embodiments, the destination shopping system 200 can also establish a connection (e.g., via Bluetooth, Near Field Communication (NFC)) with the passenger's smartphone or tablet, in order to interface with the passenger's calendar and generate more contextualized recommendations (e.g., recommendations for events in destination city). For example, the destination shopping system 200 may interface with the passenger's calendar in order to determine if the passenger has any free nights in the destination city, in which case the system can determine events that the user may attend on such free nights, and surface appropriate ads, promotions, offers, etc., for these events. As another example, the destination shopping system 200 may interface with the passenger's calendar in order to determine which areas or neighborhoods of the destination city the user is staying at a different points in time (e.g., perhaps the user has a scheduled appointment at the downtown convention center tomorrow), in which case the system can determine events that the user may attend in such areas or neighborhoods, and surface appropriate ads, promotions, offers, etc., for these events (e.g., see the user interface 1100 in FIG. 11). The destination shopping system 200 may also access other information from the passenger's smart phone to further contextualize offers, including the passenger's name, any interests or preferences of the passenger, the friends of the passenger (which may or may not include other passengers on the same flight) that may be included together in a group buy deal, and so on. For example, after syncing with the user's smart phone, the destination shopping system 200 may access a music or video playlist (e.g., iTunes playlists) of the user and determine, based on the play list, that the user likes to listen to a specific artist such as Fleetwood Mac. Thus, the destination shopping system 200 may recommend content related to this artist (e.g., offer to purchase tickets to a concert in the destination city featuring the artist) (e.g., see the user interface 1200 in FIG. 12).

FIG. 13 is a flowchart illustrating an example method 1300, consistent with various embodiments described above. The method 1300 may be performed at least in part by, for example, the destination shopping system 200 illustrated in FIG. 2 (or an apparatus having similar modules, such as client machines 110 and 112 or application server 118 illustrated in FIG. 1). In operation 1301 in FIG. 13, the content management module 204 establishes a connection with a mobile device associated with a user (e.g., a passenger) on a vehicle. In operation 1302 in FIG. 13, the content management module 204 accesses at least one of calendar information and playlist information from the mobile device associated with the passenger. In operation 1303 in FIG. 13, the content management module 204 selects contextual electronic content for display to the passenger, based on the accessed calendar information or playlist information.

According to another exemplary embodiment, the destination shopping system 200 may also track the content users are accessing via an in-flight entertainment system (e.g., what are they watching, what are they listening to, what games are they playing), in order to generate more contextualized offers. For example, if the user is listening to a particular song by a particular artist in a particular genre, the destination shopping system 200 may determine whether there are any upcoming events in the destination city related to this artist or genre (e.g., an upcoming concert) (e.g., see the user interface 1200 in FIG. 12). As another example, if the user is watching a particular movie in a particular genre with a particular cast and crew, etc., the destination shopping system 200 may determine whether there are any upcoming events in the destination city related to this movie, genre, cast or crew (e.g., an upcoming movie release or press junket at a movie theatre near the user's hotel). In some embodiments, the system may allow the user to purchase items related to the content they are consuming (e.g., apparel from a team participating in a sporting event being watched by the user).

FIG. 14 is a flowchart illustrating an example method 1400, consistent with various embodiments described above. The method 1400 may be performed at least in part by, for example, the destination shopping system 200 illustrated in FIG. 2 (or an apparatus having similar modules, such as client machines 110 and 112 or application server 118 illustrated in FIG. 1). In operation 1401 in FIG. 14, the content management module 204 monitors media disseminated to a user (e.g., a passenger) via a vehicle media playback system in the vehicle associated with the passenger, or via the passenger's mobile device. In operation 1402 in FIG. 14, the content management module 204 selects contextual electronic content for display to the passenger, based on the monitored content.

According to various embodiments, the destination shopping system 200 may provide the passenger with an option to watch movies, documentaries, or television shows, or to listen to music or to play games, that are in some way related to the passenger's destination city. For example, if the final destination of the passenger is Miami, the destination shopping system 200 may display a prompt (on the vehicle seat touchscreen facing the passenger or the passenger's smartphone), in order to ask the passenger if they would like to watch the movie “Miami Vice” or a documentary about the history of Miami (e.g., see the user interface 600 in FIG. 6).

FIG. 15 is a flowchart illustrating an example method 1500, consistent with various embodiments described above. The method 1500 may be performed at least in part by, for example, the destination shopping system 200 illustrated in FIG. 2 (or an apparatus having similar modules, such as client machines 110 and 112 or application server 118 illustrated in FIG. 1). In operation 1501 in FIG. 15, the content management module 204 identifies, based on the destination location (e.g., as determined in operation 301 in FIG. 3), at least one of film content, television show content, music content, and gaming content related to the destination location. In operation 1502 in FIG. 15, the content management module 204 selects contextual electronic content, for display to a passenger based on the identified content.

According to another exemplary embodiment, the destination shopping system 200 may keep track of the content the user is watching in a viewing session on the flight, and then allow the user to continue watching this content when the user is at another location. For example, the destination shopping system 200 can keep track of media disseminated to a passenger on their smart phone or their passenger seat display screen during the flight, and detect a “playback stop point” of where the passenger stopped consuming the content during the flight (e.g., just before they exit the flight). Thereafter, if the destination shopping system 200 detects that the passenger has logged into a media hosting service (e.g., a website of Netflix, Hulu, Amazon Prime, etc.), then the destination shopping system 200 may transmit a request to that media hosting service to resume playback of the media at the playback stop point, thereby allowing the user to continue consuming content they were consuming in-flight after the fight is over.

FIG. 16 is a flowchart illustrating an example method 1600, consistent with various embodiments described above. The method 1600 may be performed at least in part by, for example, the destination shopping system 200 illustrated in FIG. 2 (or an apparatus having similar modules, such as client machines 110 and 112 or application server 118 illustrated in FIG. 1). In operation 1601 in FIG. 16, the content management module 204 monitors media disseminated to a user or passenger (via a vehicle media playback system in the vehicle associated with the passenger, or via the passenger's mobile device). In operation 1602 in FIG. 16, the content management module 204 identifies a playback stop point corresponding to a most recent portion of the media disseminated to the passenger. In operation 1603 in FIG. 16, the content management module 204 stores the playback stop point in association with information identifying the media and the passenger. In operation 1604 in FIG. 16, the content management module 204 determines that the passenger has logged into a media hosting service. In operation 1605 in FIG. 16, the content management module 204 transmits a request to the media hosting service to resume playback of the media at the playback stop point.

According to another exemplary embodiment, the destination shopping system 200 can keep track of the content the user is watching before the flight, and then allow the user to continue watching this content when the user is on board their flight. For example, the destination shopping system 200 may receive, from a media hosting service (e.g., a website of Netflix, Hulu, Amazon Prime, etc.), data indicating a “playback stop point” of where the passenger stopped playback of a particular piece of content before the flight. Thereafter, if the destination shopping system 200 determines that the passengers has boarded the flight and/or has activated their smart phone or their passenger seat display screen, then the destination shopping system 200 may resume playback of the media at the playback stop point.

FIG. 17 is a flowchart illustrating an example method 1700, consistent with various embodiments described above. The method 1700 may be performed at least in part by, for example, the destination shopping system 200 illustrated in FIG. 2 (or an apparatus having similar modules, such as a client machines 110 and 112 or application server 118 illustrated in FIG. 1). In operation 1701 in FIG. 17, the content management module 204 receives, from a media hosting service, a playback stop point corresponding to a most recent portion of media previously disseminated to a user (e.g., passenger) via a media hosting service. In operation 1702 in FIG. 17, the content management module 204 stores the playback stop point in association with information identifying the media and the passenger. In operation 1703 in FIG. 17, the content management module 204 determines that the passenger has accessed their mobile device or a vehicle media playback system in the vehicle associated with the passenger. In operation 1704 in FIG. 17, the content management module 204 resumes playback, via the vehicle media playback system, of the media at the playback stop point.

According to various exemplary embodiments, the destination shopping systems can display suggestions for landmarks or sights for a passenger to view, based on the position or location of that passenger's seat. For example, the destination shopping system 200 can determine that a passenger is sitting on the right side of an airplane based on the seat assignment. The passenger is then provided notice of landmarks viewable out the right side of the aircraft (e.g., mountains, lakes or cities) based on the aircraft's current location.

While various embodiments throughout refer to a final destination city, it is apparent that the techniques and embodiments described herein are also applicable to, for example, intermediate destinations, overnight layover stops, etc.

### Example Mobile Device

FIG. 18 is a block diagram illustrating the mobile device 1800, according to an example embodiment. The mobile device may correspond to, for example, client machines 110 and 112 or application server 118 illustrated in FIG. 1. One or more of the modules of the system 200 illustrated in FIG. 2 may be implemented on or executed by the mobile device 1800. The mobile device 1800 may include a processor 1810. The processor 1810 may be any of a variety of different types of commercially available processors suitable for mobile devices (for example, an XScale architecture microprocessor, a Microprocessor without Interlocked Pipeline Stages (MIPS) architecture processor, or another type of processor). A memory 1820, such as a Random Access Memory (RAM), a Flash memory, or other type of memory, is typically accessible to the processor 1810. The memory 1820 may be adapted to store an operating system (OS) 1830, as well as application programs 1840, such as a mobile location enabled application that may provide location based services to a user. The processor 1810 may be coupled, either directly or via appropriate intermediary hardware, to a display 1850 and to one or more input/output (I/O) devices 1860, such as a keypad, a touch panel sensor, a microphone, and the like. Similarly, in some embodiments, the processor 1810 may be coupled to a transceiver 1870 that interfaces with an antenna 1890. The transceiver 1870 may be configured to both transmit and receive cellular network signals, wireless data signals, or other types of signals via the antenna 1890, depending on the nature of the mobile device 1800. Further, in some configurations, a GPS receiver 1880 may also make use of the antenna 1890 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 19 is a block diagram of machine in the example form of a computer system 1900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1900 includes a processor 1902 (e.g., a central processing unit (CPU), a graphics processing unit (GPU) or both), a main memory 1904 and a static memory 1906, which communicate with each other via a bus 1908. The computer system 1900 may further include a video display unit 1910 (e.g., a liquid crystal display (LCD) or a cathode ray tube (CRT)). The computer system 1900 also includes an alphanumeric input device 1912 (e.g., a keyboard or a touch-sensitive display screen), a user interface (UI) navigation device 1914 (e.g., a mouse), a disk drive unit 1916, a signal generation device 1918 (e.g., a speaker) and a network interface device 1920.

### Machine-Readable Medium

The disk drive unit 1916 includes a machine-readable medium 1922 on which is stored one or more sets of instructions and data structures (e.g., software) 1924 embodying or utilized by any one or more of the methodologies or functions described herein. The instructions 1924 may also reside, completely or at least partially, within the main memory 1904 and/or within the processor 1902 during execution thereof by the computer system 1900, the main memory 1904 and the processor 1902 also constituting machine-readable media.

While the machine-readable medium 1922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1924 may further be transmitted or received over a communications network 1926 using a transmission medium. The instructions 1924 may be transmitted using the network interface device 1920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
determining a destination location of a passenger on a vehicle;
selecting, by a machine having a memory and at least one processor, contextual electronic content based on the destination location of the passenger; and
displaying, via a user interface, the contextual electronic content.

2. The method of claim 1, wherein the destination location is determined based on electronic passenger information included in a passenger itinerary, passenger record, or passenger manifest associated with the passenger.

3. The method of claim 1, wherein the contextual electronic content is displayed on a mobile device associated with the passenger.

4. The method of claim 1, wherein the contextual electronic content is displayed on a vehicle seat display screen in the vehicle that is associated with the passenger.

5. The method of claim 1, wherein the contextual electronic content includes at least one of an advertisement, a coupon, a promotion, and a product recommendation.

6. The method of claim 1, wherein the contextual electronic content includes a recommendation for a product or service determined to be historically popular among other passengers traveling to the destination location.

7. The method of claim 1, wherein the contextual electronic content includes a recommendation for a product or service determined based on a current or predicted whether condition at the destination location.

8. The method of claim 1, wherein the contextual electronic content includes a recommendation for a product or service determined based on at least one of an origin location associated with the passenger, a flyover location associated with the vehicle, and the destination location.

9. The method of claim 1, further comprising automatically specifying, based on the destination location, a delivery address in conjunction with a product purchase selection by the passenger, the delivery address corresponding to a destination airport or destination hotel associated with the passenger.

10. The method of claim 1, further comprising automatically specifying, based on electronic payment information associated with the passenger, payment information in conjunction with a product purchase selection by the passenger.

11. The method of claim 1, wherein the displaying further comprises:
determining that the passenger is occupying an alternate seat associated with an additional passenger; and
displaying the contextual electronic content on a vehicle seat display screen in the vehicle that is associated with the alternate seat.

12. The method of claim 1, further comprising:
determining that the passenger is associated with one or more additional passengers in the vehicle; and
displaying the contextual electronic content to the passenger and the one or more additional passengers.

13. The method of claim 12, wherein the contextual electronic content corresponds to an offer or recommendation for a group buy deal.

14. The method of claim 1, wherein the selecting further comprises:
establishing a connection with a mobile device associated with the passenger;
accessing at least one of calendar information and playlist information associated with the passenger from the mobile device; and
selecting the contextual electronic content, based on the accessed calendar information or playlist information.

15. The method of claim 1, wherein the selecting further comprises:
monitoring media disseminated to the passenger via a vehicle media playback system in the vehicle associated with the passenger; and
selecting the contextual electronic content, based on the monitored content.

16. The method of claim 1, wherein the selecting further comprises:
identifying, based on the destination location, at least one of film content, television show content, music content, and gaming content related to the destination location; and
selecting the contextual electronic content, based on the identified content.

17. The method of claim 1, further comprising:
monitoring media disseminated to the passenger via a vehicle media playback system in the vehicle associated with the passenger,
identifying a playback stop point corresponding to a most recent portion of the media disseminated by the passenger;
storing the playback stop point in association with information identifying the media and the passenger;
determining that the passenger has logged into a media hosting service; and
transmitting a request to the media hosting service to resume playback of the media at the playback stop point.

18. The method of claim 1, further comprising:
receiving, from a media hosting service, a playback stop point corresponding to a most recent portion of media previously disseminated by the passenger via the media hosting service;
storing the playback stop point in association with information identifying the media and the passenger;
determining that the passenger has accessed a vehicle media playback system in the vehicle associated with the passenger; and
resuming playback, via the vehicle media playback system, of the media at the playback stop point.

19. A system comprising:
a machine including a memory and at least one processor;
a determination module, executable by the machine, configured to determine a destination location of a passenger on a vehicle; and
a content management module configured to:
select contextual electronic content based on the destination location of the passenger; and
display, via a user interface, the contextual electronic content.

20. A non-transitory machine-readable storage medium comprising instructions that, when executed by one or more processors of a machine, cause the machine to perform operations comprising:
determining a destination location of a passenger on a vehicle;
selecting contextual electronic content based on the destination location of the passenger; and
displaying, via a user interface, the contextual electronic content.
